(19) United States
(12) Patent Application Publication
(10) Pub. No.: US 2025/0223838 A1
(43) Pub. Date: Jul. 10, 2025

(54) Electronic device lock

(71) Applicant: INGAMAR CO., LTD., CHANGHUA COUNTY (TW)

(72) Inventor: Jason Su, CHANGHUA COUNTY (TW)

(73) Assignee: INGAMAR CO., LTD., CHANGHUA COUNTY (TW)

(21) Appl. No.: 18/406,012

(22) Filed: Jan. 5, 2024

(51) Int. Cl. E05B 37/02; E05B 47/00

(52) U.S. Cl. CPC E05B 37/025; E05B 47/0001

(57) ABSTRACT

An electronic device lock includes a lock and a cable. The lock has a lock lever equipped with a plurality of number wheels. The number wheels control the displacement of the lock lever, and the lock lever is moved by the switch control button to form a connection or disconnection state between the lock and an electric device. The lock lever is equipped with a buckle part, and the lock is further provided with a buckle hole corresponding to the buckle part. An insert part is provided at one end of the cable, and the other end forms a collar part. The insert part is inserted into the buckle hole of the lock, and the displacement of the lock lever drives the buckle part and the insert part to form a buckle connection or disengage.

### BACKGROUND OF THE INVENTION

### Field of the Invention

This invention relates to a lock with a cable, in particular, the cable can be plugged in and out of the lock at any time, so that the cable can be connected to a fixed object, and the electronic devices can be restricted to the fixed object through the lock and the cable.

### Description of the Related Art

The consumer electronic products, such as laptop computers and tablet computers, tend to be designed to be lighter, thinner, and smaller. However, because the electronic products are light and thin and can be carried away in an instant, they have become a coveted target for thieves, especially in crowded places or unmanned offices. In order to improve this phenomenon, some manufacturers have developed a computer lock structure.

The conventional computer lock includes a lock and a cable. The lock is inserted into the lock hole of the electronic device and the cable is wound around and tied to a fixed object such as a table leg. The electronic device is locked around the fixed object to achieve the purpose of locking. However, the cable of the current computer lock is directly assembled and fixed on the lock, and the cable can only be detached through the disassembly of the lock, so that the cable does not have the functions of plugging and detaching from the lock. When the computer lock is used, the cable must be looped and tied to the fixed object first, and then the lock must be plugged into and the keyhole of the electronic device to achieve the locking function, causing the cable to be unable to be arbitrarily changed the connecting fixture. In addition, the reserved length of the cable must be quite accurate so that the electronic device can be locked and restricted while maintaining the movement effect, which has the disadvantage of being difficult to operate. Further, since one end of the cable is fixed on the lock and the other end forms a collar part, this makes it difficult for the cable to pass through a hole with the same diameter or slightly larger than the cable so that the cable can only be connected to the fixed object through looping or tying, which is more inconvenient and lacks practicality.

### SUMMARY OF THE INVENTION

The technical problem to be solved by this invention is to provide an electronic device lock that facilitates the separation of the lock and the cable in view of the above-mentioned deficiencies in conventional technology.

The electronic device lock includes a lock and a cable. The lock has a lock lever equipped with a plurality of number wheels. The number wheels control the displacement of the lock lever, and the lock lever is moved by the switch control button to form a connection or disconnection state between the lock and an electric device. The lock lever is equipped with a buckle part, and the lock is further provided with a buckle hole corresponding to the buckle part. An insert part is provided at one end of the cable, and the other end forms a collar part. The insert part is inserted into the buckle hole of the lock, and the displacement of the lock lever drives the buckle part and the insert part to form a buckle connection or disengage, so that the cable and the lock can be fastened or disengaged at any time to facilitate the fixing of the cable with a fixed object.

Preferably, one end of the lock lever is sequentially equipped with an operating block and a push pillar. A fitting hole is recessed on one side of the operating block, and a buckle part is protruding on the other side of the operating block. The push pillar is a conical rod with a tip. A housing is a two-piece symmetrical cover that covers the lock lever and the number wheel. The housing is provided with a plurality of through holes for partially exposing the number wheel for operating, and is provided with a plurality of perspective holes used for viewing the number of the number wheel. The housing is provided with a displacement space and an arc-shaped ball chamber connected with each other. The displacement space accommodates the operating block, the ball chamber provides the penetration of the push pillar, and an opening is formed from the top of the ball chamber through the housing. An operating hole and a buckle hole are provided on both sides of the housing to communicate with the displacement space, the operating hole is connected to the fitting hole to provide the connection of the switch control button, the end of the buckle part of the operating block is protruding from the buckle hole, the two fasteners are symmetrically provided with hemispherical arc parts, and the two arc parts are accommodated in the ball chamber. An accommodation tank is formed inside the two arc parts to equip the push pillar. A buckle arm is formed at one end of the arc parts and passes out of the housing through the opening.

Preferably, a spring is inserted under the operating block of the lock lever, the spring is located between the operating block and the number wheel.

Preferably, a first annular groove is recessed on the inner surface of the ball chamber, at least one slider is protruding on the outside of the two arc parts, and the slider can be slidably equipped in the first annular groove. Two block parts symmetrically protrude inside the accommodation tank, and the push pillar is tapered toward the direction of the operating block to form a tapered part. When the tapered part presses against the block parts of the two fasteners, the two fasteners swing with the slider as the axis and the two buckle arms are relatively close to each other.

Preferably, the switch control button is connected with the fitting hole by a cylinder.

Preferably, a second annular groove is provided in the ball chamber adjacent to the opening. A cover is sandwiched between the second annular groove, and the cover is provided with a through hole through which the two buckle arms can pass.

Compared with conventional technology, the present invention has several advantages. The cable and the lock are connected and fixed through a buckle method, and the lock lever can be driven by moving the switch control button to unlock the buckle state so that the cable can be buckled or detached from the lock independently and at any time. When the lock is connected and fixed with a fixed object through the cable, the cable can first be detached from the lock to be looped or separately connected to a fixed object, which greatly improves the variability and convenience of the connection of the cable. It can also reduce the size of the collar part at the other end of the cable, which helps to improve the tightness of the cable.

### BRIEF DESCRIPTION OF THE DRAWINGS

The following drawings are merely examples for illustrative purposes according to various disclosed embodiments and are not intended to limit the scope of the present disclosure.

FIG. 1 is a three-dimensional view of this invention.

FIG. 2 is an exploding view of this invention.

FIG. 3 is a combined cross-sectional view of this invention.

FIG. 4 is a schematic diagram of the cable of this invention connected by the buckle part and the buckle hole of the lock.

FIG. 5 is a cross-sectional view of the cable of this invention connected by the buckle part and the buckle hole of the lock.

FIG. 6 is a schematic diagram of the other end of the cable of this invention being looped around a fixed object.

FIG. 7 is a schematic diagram of the lock and cable of this invention to restrict the electronic device to the fixed object.

FIG. 8 is a schematic diagram of the lock and cable of this invention connected in series to lock multiple electronic devices.

FIG. 9 is a schematic diagram showing the unlocking action of the lock and the cable of this invention.

FIG. 10 is a schematic diagram showing the unlocking state of the lock and the cable of this invention.

### DETAILED DESCRIPTION OF THE INVENTION

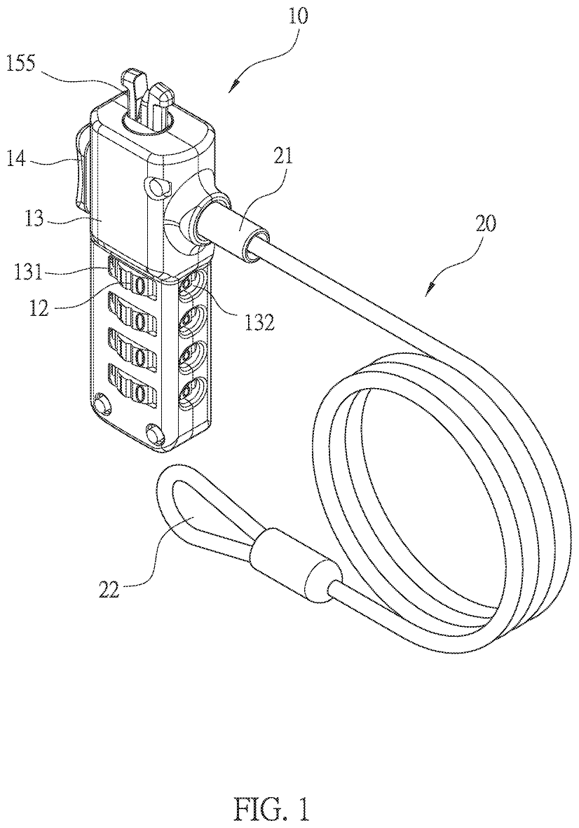

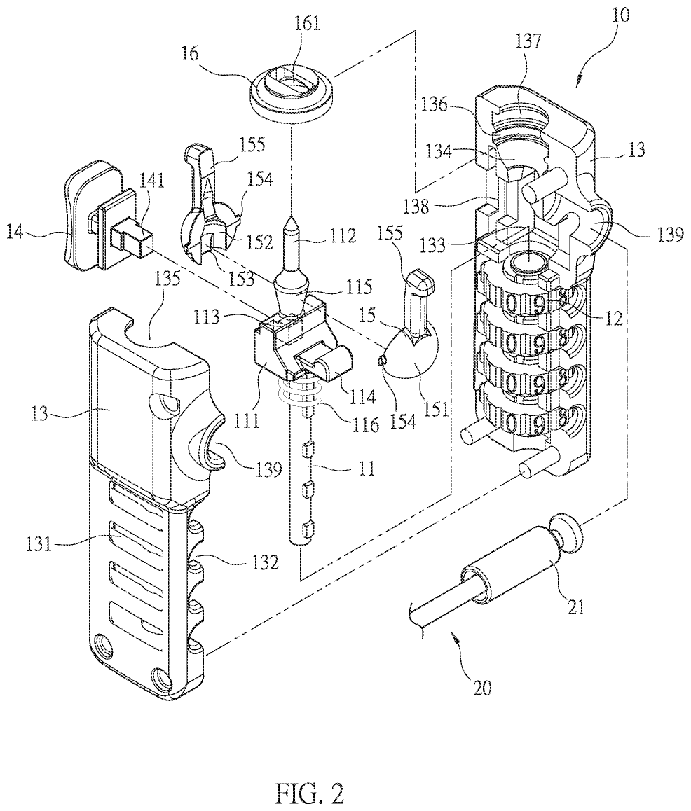

First, as shown in FIGS. 1 and 2, an electronic device lock includes a lock 10 and a cable 20. The lock 10 has a lock lever 11, a plurality of number wheels 12, a housing 13, a switch control button 14, and two fasteners 15. The lock lever 11 is equipped with a plurality of number wheels 12, the number wheels 12 control the displacement of the lock lever 11, one end of the lock lever 11 is sequentially equipped with an operating block 111 and a push pillar 112. A fitting hole 113 is recessed on one side of the operating block 111, and a buckle part 114 is protruding on the other side of the operating block 111. The push pillar 112 is a conical rod with a tip, and the push pillar 112 is tapered toward the direction of the operating block 111 to form a tapered part 115. A spring 116 is inserted under the operating block 111 of the lock lever 11, the spring 116 is located between the operating block 111 and the number wheel 12. The housing 13 is a two-piece symmetrical cover that covers the lock lever 11 and the number wheel 12. The housing 13 is provided with a plurality of through holes 131 for partially exposing the number wheel 12 for operating, and is provided with a plurality of perspective holes 132 used for viewing the number of the number wheel 12. The housing 13 is provided with a displacement space 133 and an arc-shaped ball chamber 134 connected with each other. The displacement space 133 accommodates the operating block 111, the ball chamber 134 provides the penetration of the push pillar 112, and an opening 135 is formed from the top of the ball chamber 134 through the housing 13. A first annular groove 136 is recessed on the inner surface of the ball chamber 134, and a second annular groove 137 is provided in the ball chamber 134 adjacent to the opening 135. An operating hole 138 and a buckle hole 139 are provided on both sides of the housing 13 to communicate with the displacement space 133, the operating hole 138 is connected to the fitting hole 113 to provide the connection of the switch control button 14, the switch control button 14 is connected with the fitting hole 113 by a cylinder 141, the end of the buckle part 114 of the operating block 111 is protruding from the buckle hole 139, the two fasteners 15 are symmetrically provided with hemispherical arc parts 151, and the two arc parts 151 are accommodated in the ball chamber 134. An accommodation tank 152 is formed inside the two arc parts 151 to equip the push pillar 112, the push pillar 112 is provided with two block parts 153 symmetrically protruding inside the accommodation tank 152, at least one slider 154 is protruding on the outside of the two arc parts 151, and the slider 154 can slidably equipped in the first annular groove 136. A buckle arm 155 is formed at one end of the arc parts 151 and passes out of the housing 13 through the opening 135. A cover 16 is sandwiched between the second annular groove 137, the cover 16 is provided with a through hole 161 through which the two buckle arms 155 can pass. One end of the cable 20 is provided with a insert part 21, and the other end is formed with a collar part 22. The insert part 21 is inserted into the buckle hole 139 of the lock 10, and the displacement of the lock lever 11 drives the buckle part 114 and the insert part 21 to form a buckle connection or disengage, so that the cable 20 and the lock 10 can be fastened or disengaged at any time to facilitate the fixing of the cable 20 with a fixed object.

The structure is further shown in FIGS. 1-3. The lock lever 11 and the number wheel 12 of the lock 10 are first assembled in the housing 13. The operating block 111 of the lock lever 11 is disposed in the displacement space 133 so as to be able to move up and down. The push pillar 112 is passed through the ball chamber 134 and the opening 135, and the spring 116 is disposed between the operating block 111 and the number wheel 12 adjacent to the operating block 111. The lock lever 11 can be in a normal upward pushing state by the elastic stress of the spring 116, and the end of the buckle part 114 of the operating block 111 can protrude from the inner surface of the buckle hole 139. The cylinder 141 of the switch control button 14 is connected to the fitting hole 113 of the operating block 111 through the operating hole 138, so that the switch control button 14 can drive the lock lever 11 to move downward. Two fasteners 15 are combined and assembled into the ball chamber 134 of the housing 13, and is displaceably restricted in the first annular groove 136 by using the slider 154 on the surface of the arc part 151. At the same time, the push pillar 112 is located inside the two fasteners 15. Since the lock lever 11 is normally pushed by the spring 116, the top of the push pillar 112 exceeds the range of the accommodation tank 152 and the buckle arm 155 of the two fasteners 15 are pushed outward to unfold, and the tapered part 115 is located above the two block parts 153 of the accommodation tank 152, so that the buckle arms 155 of the two fasteners 15 form a normally locking state. The cover 16 is rotatably assembled in the second annular groove 137 of the ball chamber 134, so that the two buckle arms 155 can pass through the through hole 161, and the cover 16 and the two fasteners 15 have a synchronous rotation state. The insert part 21 of the cable 20 is inserted into the buckle hole 139 of the lock 10, and the lock state of the insert part 21 and the buckle part 114 can be released through the switch control button 14.

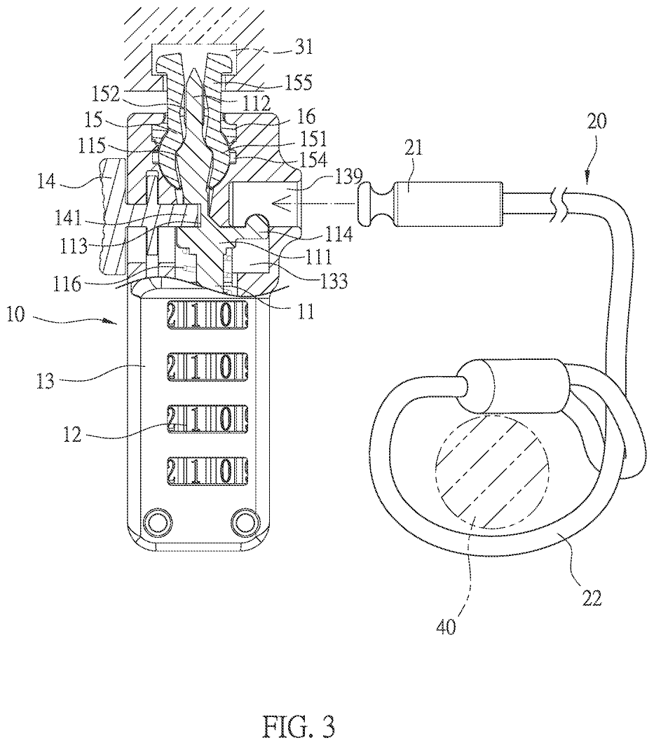

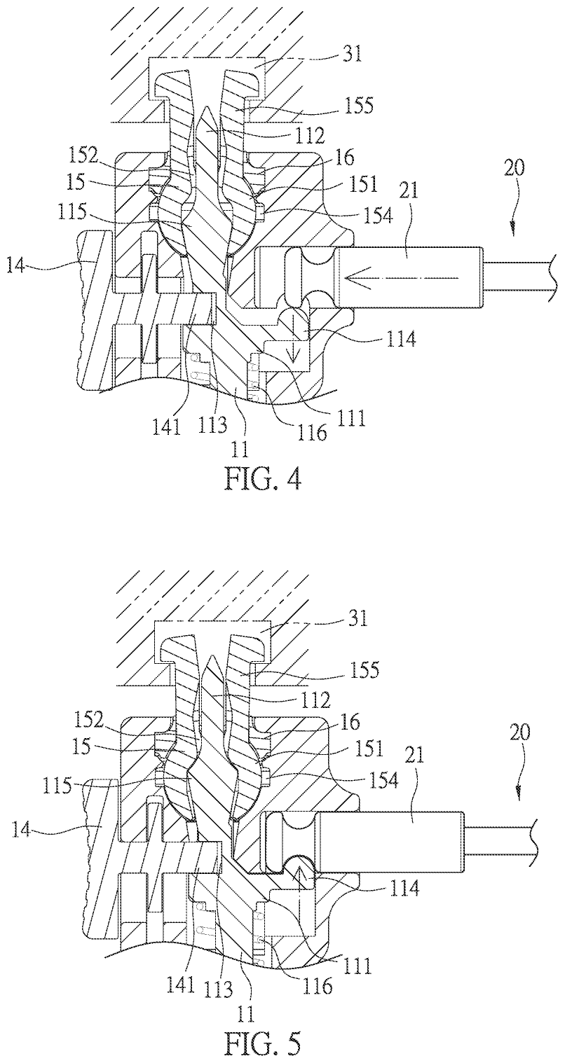

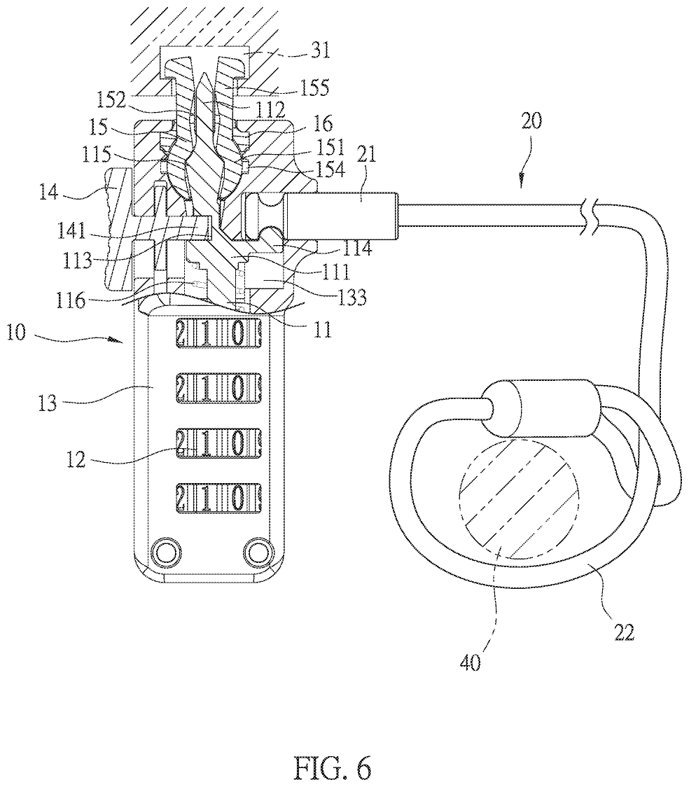

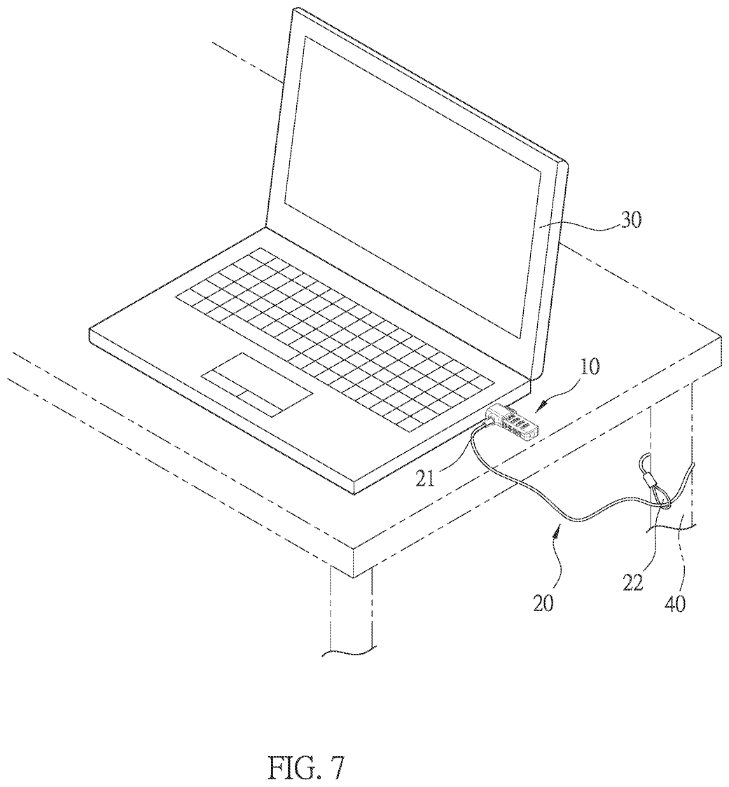

As shown in FIGS. 3-7, the lock 10 utilizes two buckle arms 155 of the fasteners 15 and a preset buckle hole 31 of an electronic product 30 to connect, and the cable 20 is positioned around a fixed object 40 and then the insert part 21 is plugged and fixed with the buckle hole 139 of the lock 10. Because the lock lever 11 is normally pushed by the spring 116 to form a locking state, and the end of the buckle part 114 is normally protruding from the inner surface of the buckle hole 139, when the insert part 21 is inserted into the buckle hole 139, the buckle part 114 will be squeezed down first, and then the spring 116 rebounds and resets to push the buckle part 114 upward to buckle the insert part 21. Thereby the cable 20 and the lock 10 are connected, and the electronic device 30 is limited to the nearby area of the fixed object 40, such as table legs, preset holes or preset lock rings. Finally, the number wheel 12 is turned and disrupted, so that the lock lever 11 is locked and cannot pass through the switch control button 14 to achieve the anti-theft purpose of the electronic device 30.

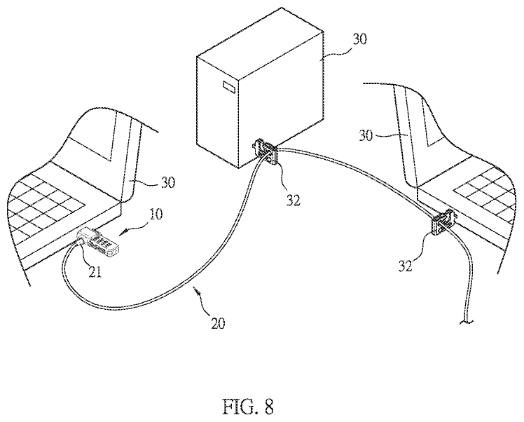

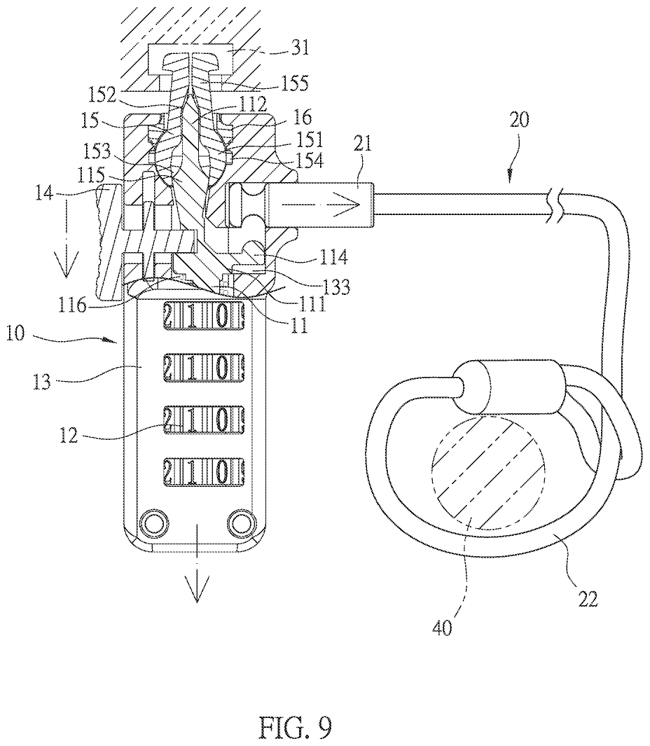

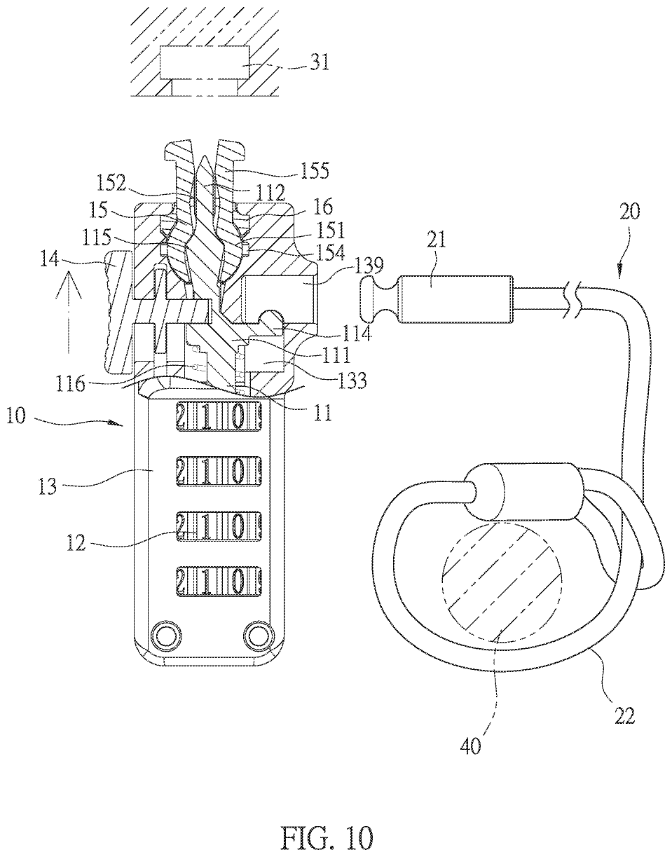

In addition, because the insert part 21 of the cable 20 and the lock 10 are buckled and connected through the buckle part 114 of the lock lever 11, and the lock lever 11 is moved by the switch control button 14 to form a connection or disconnection state, so that the cable 20 can be buckled or disconnected from the lock 10 at any time. When the lock 10 wants to restrict multiple electronic devices 30 or equipment in series through the cable 20, by pushing and pressing the lock lever 11 through the switch control button 14, the buckle part 114 moves downward and away from the insert part 21, so that the insert part 21 of the cable 20 can be separated from the insert part 21 alone, as shown in FIGS. 8-10. The lock 10 then utilizes the cylindrical design of the cable 20 and the insert part 21 to easily pass through the lock ring 42 preset in other electronic devices 40 or equipment, and finally is fixed with the lock 10, so that it can be quickly and reliably lock multiple electronic devices in series, greatly improving the practicality of the structure.

Furthermore, when the user wants to unlock the lock 10 and separate from the electronic device 30, firstly turn the number wheel 12 and select the correct combination, and then push down the lock lever 11 through the switch control button 14, move the push pillar 112 downward and retract, and sink the tapered part 115 to press against the block parts 153 of the two fasteners 15. At this time, the two fasteners 15 swing with the slider 154 as the axis and the two buckle arms 155 are relatively close to each other so that the two buckle arms 155 can be pulled out from the buckle hole 31 of the electronic device 30 to achieve the purpose of unlocking. When the switch control button 14 is released, the lock lever 11 will be pushed up by the spring 116 again, so that the two buckle arms 155 of the fasteners 15 return to the outwardly deployed locking state, and the end of the buckle part 114 is also reset and protrudes from the inner surface of the buckle hole 139.

With the structure of the above embodiments, the following benefits can be obtained. The cable 20 and the lock 10 are connected and fixed through a buckle method, and the lock lever 11 can be driven by moving the switch control button 14 to unlock the buckle state so that the cable 20 can be buckled or detached from the lock 10 independently and at any time. When the lock is connected and fixed with a fixed object through the cable 20, the cable 20 can first be detached from the lock 10 to be looped or separately connected to a fixed object, which greatly improves the variability and convenience of the connection of the cable 20. It can also reduce the size of the collar part 22 at the other end of the cable 20, which helps to improve the tightness of the cable 20.

What is claimed is:

1. An electronic device lock comprising:
a lock, the lock comprises a lock lever equipped with a plurality of number wheels, the number wheels control the displacement of the lock lever, the lock lever is moved by a switch control button to form a connection or disconnection state between the lock and an electric device, the lock lever is equipped with a buckle part, and the lock is further provided with a buckle hole corresponding to the buckle part; and
a cable, an insert part is provided at one end of the cable, the other end forms a collar part, the insert part is inserted into the buckle hole of the lock, and the displacement of the lock lever drives the buckle part and the insert part to form a buckle connection or disengage so that the cable and the lock can be fastened or disengaged at any time to facilitate the fixing of the cable with a fixed object.

2. The electronic device lock of claim 1, wherein one end of the lock lever is sequentially equipped with an operating block and a push pillar, a fitting hole is recessed on one side of the operating block, and the buckle part is protruding on the other side of the operating block, the push pillar is a conical rod with a tip, a housing is a two-piece symmetrical cover that covers the lock lever and the number wheel, the housing is provided with a plurality of through holes for partially exposing the number wheel for operating, and is provided with a plurality of perspective holes used for viewing the number of the number wheel, the housing is provided with a displacement space and an arc-shaped ball chamber connected with each other, the displacement space accommodates the operating block, the ball chamber provides the penetration of the push pillar, an opening is formed from the top of the ball chamber through the housing, an operating hole and a buckle hole are provided on both sides of the housing to communicate with the displacement space, the operating hole is connected to the fitting hole to provide the connection of the switch control button, the end of the buckle part of the operating block is protruding from the buckle hole, two fasteners are symmetrically provided with hemispherical arc parts, and the two arc parts are accommodated in the ball chamber, an accommodation tank is formed inside the two arc parts to equip the push pillar, a buckle arm is formed at one end of the arc parts and passes out of the housing through the opening.

3. The electronic device lock of claim 2, wherein a spring is inserted under the operating block of the lock lever, the spring is located between the operating block and the number wheel.

4. The electronic device lock of claim 2, wherein a first annular groove is recessed on the inner surface of the ball chamber, at least one slider is protruding on the outside of the two arc parts, the slider can be slidably equipped in the first annular groove, two block parts symmetrically protrude inside the accommodation tank, the push pillar is tapered toward the direction of the operating block to form a tapered part, when the tapered part presses against the block parts of the two fasteners, the two fasteners swing with the slider as the axis and the two buckle arms are relatively close to each other.

5. The electronic device lock of claim 2, wherein the switch control button is connected with the fitting hole by a cylinder.

6. The electronic device lock of claim 2, wherein a second annular groove is provided in the ball chamber adjacent to the opening, a cover is sandwiched between the second annular groove, and the cover is provided with a through hole through which the two buckle arms can pass.
